(19) United States
(12) Patent Application Publication
(10) Pub. No.: US 2012/0208478 A1
(43) Pub. Date: Aug. 16, 2012

(54) SYSTEM AND METHOD FOR CONTROLLING POWER LEVELS

(75) Inventors: Ben Greenwood, Calgary (CA); Kevin Clancy, Calgary (CA); Slim Souissi, San Diego, CA (US)

(73) Assignee: NOVATEL WIRELESS INC., San Diego, CA (US)

(21) Appl. No.: 13/458,789

(22) Filed: Apr. 27, 2012

Related U.S. Application Data
(63) Continuation of application No. 12/509,113, filed on Jul. 24, 2009.
(60) Provisional application No. 61/186,729, filed on Jun. 12, 2009.

(51) Int. Cl. H04W 52/02

(52) U.S. Cl. 455/127.1

(57) ABSTRACT

An apparatus comprises a radio frequency (RF) signal source; and a controller configured to adjust power of the RF signal source based on a detected parameter. In one embodiment, the apparatus further comprises a proximity sensor configured to determine proximity of the RF signal source to live tissue, and the detected parameter is the proximity determined by the proximity sensor. The RF signal source may be an RF antenna. The controller may be configured to reduce the power of the RF signal source when the proximity is less than a predetermined threshold value. The controller may be configured to reduce the power to a predetermined reduced power level.

### RELATED APPLICATIONS

This application is a Continuation of U.S. patent application Ser. No. 12/509,113, filed on Jul. 24, 2009, which claims priority from U.S. Provisional Application Ser. No. 61/186,729, filed on Jun. 12, 2009, each of which are incorporated herein by reference in its entirety for all purposes.

### BACKGROUND OF THE INVENTION

The present invention relates generally to portable communication devices and, more particularly, to systems and methods for controlling power levels for such portable communication devices.

### SUMMARY OF THE INVENTION

One aspect of the invention relates to an apparatus comprising a radio frequency (RF) signal source; a proximity sensor configured to determine proximity of the RF signal source to live tissue; and a controller configured to adjust power of the RF signal source based on the determined proximity of the RF signal source to the live tissue.

In one embodiment, the RF signal source is an RF antenna.

In one embodiment, the controller is configured to reduce the power of the RF signal source when the proximity is less than a predetermined threshold value. The controller may be configured to reduce the power to a predetermined reduced power level. In a particular embodiment, the controller is configured to reduce the power to a level corresponding to the proximity to live tissue. In one embodiment, the predetermined threshold value is associated with a maximum distance required for an acceptable specific absorption rate (SAR) level. In one embodiment, the controller is configured to adjust the power to result in a SAR for the live tissue from the RF signal source to be no greater than a predetermined SAR.

In one embodiment, to adjust the power to result in the SAR, the controller is further configured to calculate a maximum power value required for an acceptable SAR based on the determined proximity.

In one embodiment, the proximity sensor is an optical proximity sensor. In another embodiment, the proximity sensor includes an accelerometer configured to determine an orientation of the RF signal source.

In one embodiment, the controller is configured to adjust the power based on an inverse relationship between power level of the RF signal source and the proximity of the RF signal source to the live tissue.

In another aspect, the invention relates to a method comprising detecting, via a proximity sensor, proximity of a radio frequency (RF) signal source to live tissue; and adjusting power of the RF signal source based on the detected proximity.

In one embodiment, the RF signal source is an RF antenna. In one embodiment, the adjusting of the power includes reducing the power of the RF signal source when the proximity is less than a predetermined threshold value. The power may be reduced to a predetermined reduced power level. In a particular embodiment, the power is reduced to a level corresponding to the proximity to live tissue. In one embodiment, the predetermined threshold value is associated with a maximum distance required for an acceptable specific absorption rate (SAR) level. In one embodiment, the power is adjusted to result in a SAR for the live tissue from the RF signal source to be no greater than a predetermined SAR. In one embodiment, the method further comprises calculating a maximum power value required for an acceptable SAR based on the determined proximity

In one embodiment, the adjusting of the power is based on an inverse relationship between power level of the RF signal source and the proximity of the RF signal source to the live tissue.

### BRIEF DESCRIPTION OF THE DRAWINGS

FIG. 1 is a perspective illustration of a device in accordance with an embodiment of the present invention;

FIG. 2 is a schematic illustration of a device in accordance with an embodiment of the present invention; and

FIGS. 3-5 are flow charts of methods in accordance with embodiments of the present invention.

### DETAILED DESCRIPTION OF THE PREFERRED EMBODIMENTS

Portable communication devices commonly transmit radio frequency (RF) signals through an antenna. Such communication devices may be used in a variety of manners and in a variety of conditions. For various reasons, it may be desirable to automatically adjust the power level of the RF signal source based on the manner of use or the conditions under which the device is being used.

For example, exposure to RF radiation from the RF signal source may be harmful to human tissue. Accordingly, government regulations often require such devices to satisfy certain criteria associated with exposure. For example, the Federal Communications Commission (FCC) of the United States requires devices, such as USB dongles, to be tested to ensure that the specific absorption rate (SAR) of such devices is below acceptable levels. SAR is a measure of the rate at which RF power is dissipated by body tissue.

In order to comply with regulations of government agencies, such as the FCC, communication devices must be tested to ensure that the SAR levels from such devices are within acceptable levels. For example, until recently, the FCC required devices to be tested at a separation of 1.5 cm between the device and a phantom simulating human body tissue. Recently, the FCC has required that the separation distance in such tests be reduced to 0.5 cm.

The SAR level is based on the power level of the RF signal source, such as the antenna of the device, and the proximity of the RF signal source to live tissue, such as human tissue. Greater power level and closer proximity result in greater SAR levels. Conversely, lower power level and increased distance result in lower SAR levels.

Thus, the recent change in testing requirement to a shorter distance may result in more stringent SAR requirements. One way to reduce the SAR level to comply with such requirements is to expand the housing of the device to increase the difference between the RF signal source and the human tissue. However, this may result in unnecessarily enlarging the device, thereby making it less attractive to users.

In accordance with embodiments of the present invention, the device may be provided with a proximity sensor to determine the distance of the of the RF signal source from the human body close to the device. When the distance is determined to be below a certain predetermined threshold, the power level of the signal source (e.g., transmit power of the portable device) may be reduced in order to reduce the SAR level.

Depending on the radiation pattern of the antenna, multiple sensors may be provided to sense proximity from any side of the device. The proximity sensor may a capacitive, magnetic, inductive, photocell, passive optical sensor or other such sensor.

In another embodiment, the proximity sensor may include an accelerometer. The accelerometer may be used to determine if the orientation of the device corresponds to a position in which the device is being used or to a position which may result in SAR issues.

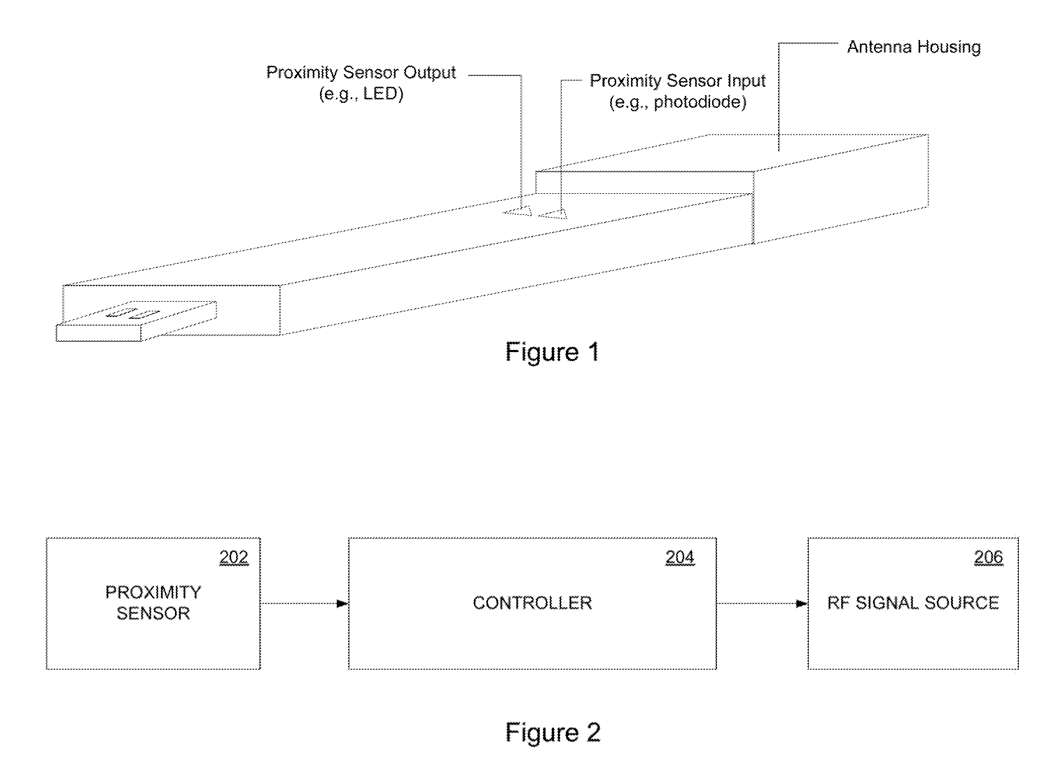

Referring now to FIG. 1, a device in accordance with an embodiment of the present invention is illustrated. In the embodiment of FIG. 1, the device is a USB dongle with a housing having an antenna therein. The device may include various other components, such as a modem device or other communication components. The device includes a proximity sensor, such as a photodiode. Additionally, the embodiment illustrated in FIG. 2 further includes a proximity sensor output, such as an LED.

Referring now to FIG. 2, a device in accordance with an embodiment of the present invention is schematically illustrated. The device illustrated in FIG. 2 may be any of a variety of communication devices, particularly portable communication devices, with an RF signal source 206 for facilitating communication. As noted above, the RF signal source 206 may be an antenna.

In addition to the RF signal source 206, the device includes a proximity sensor 202. The proximity sensor is configured to determine proximity of the RF signal source 206 to live tissue. In this regard, the proximity sensor 202 may be configured according to the radiation pattern of the RF signal source 206.

Further, the device includes a controller 204. The controller 204 may be implemented in a variety of manners, including firmware or hardware. In one embodiment, the controller 204 may be the processor of the communication device. The controller 204 is configured to receive information from the proximity sensor 202 to indicate proximity to live tissue. The controller 204 is further configured to communicate instructions to the RF signal source 206. In this regard, the controller 204 may control the power source for the RF signal source 206. Thus, the controller 204 may adjust power of the RF signal source 206 based on the proximity determined by the proximity sensor 202.

In one embodiment, the controller 204 is configured to reduce the power of the RF signal source 206 when the proximity is less than a predetermined threshold value. Thus, in one example, if SAR levels resulting from the RF signal source 206 are only acceptable at 1.0 cm from live tissue, the controller 204 may reduce the power level when the proximity sensor 202 indicates a distance to live tissue of less than 1.0 cm. In one embodiment, the amount of reduction in the power level may be predetermined. In the above example, if the proximity sensor 202 indicates a distance to live tissue of less than 1.0 cm, the power level may be reduced to 50% of normal power level.

In another embodiment, the reduction of power may correspond to the proximity to live tissue. In this regard, the controller may reduce power level in a variable manner depending on the detected distance to live tissue. Thus, with decreasing distance to live tissue, the power level may be reduced even further.

In one embodiment, the controller 204 is configured to reduce the power to result in a SAR for the live tissue from the RF signal source 206 to be no greater than a predetermined SAR. In this regard, the controller 204 may calculate a maximum power value required for acceptable SAR based on the detected distance.

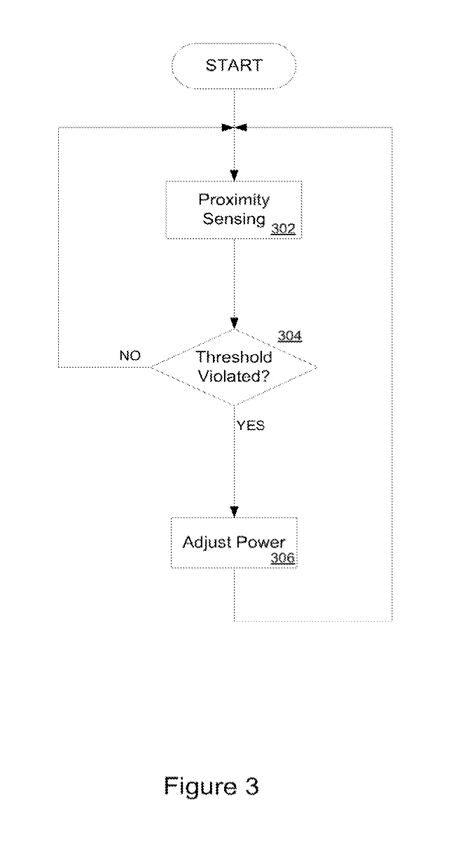

Referring now to FIG. 3, a flow chart illustrates a method in accordance with an embodiment of the present invention. The method comprises proximity sensing 302 as may be performed by the proximity sensor. In this regard, the sensing may be performed continuously, intermittently or on another effective basis. At block 304, a determination is made as to whether a threshold proximity value has been violated. As noted above, the threshold value may be associated with a maximum distance required for acceptable SAR levels. If the threshold is not violated, the process returns to block 302 and continues proximity sensing. Otherwise, at block 306, the power level of the RF signal source is adjusted based on the detected proximity value.

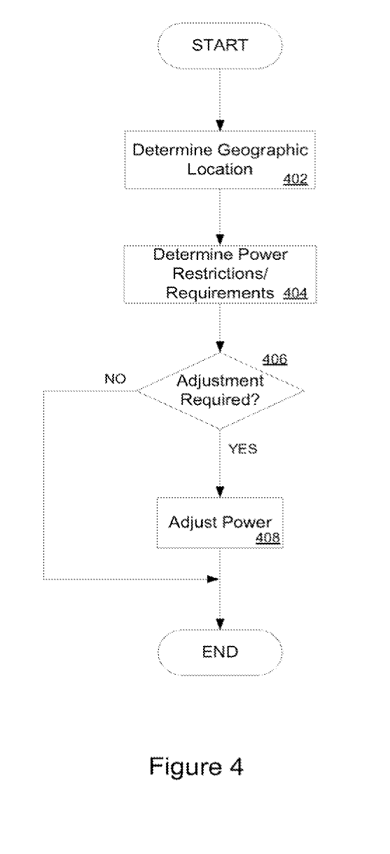

Thus, in one embodiment, the power level of the RF signal source may be adjusted based on its proximity to living tissue. In other embodiments, the power level may be adjusted based on other detected parameters. For example, in one embodiment, the power level may be adjusted based on the geographic location of the device, as illustrated in the example flow chart of FIG. 4. The method comprises determining the geographic location of the device (block 402). In this regard, the location may be determined through a variety of mechanisms. For example, the location may be determined through the use of the Global Positioning System (GPS), Assisted GPS (AGPS), Cell ID, triangulation, Mobile Switching Center Identification (MSC ID) or Network identification.

At block 404, location-based restrictions applicable to the power level of the RF signal source are determined. Such location-based restrictions may be, for example, regulatory restrictions imposed by a government agency. For example, the Federal Communications Commission (FCC) of the United States of America may impose rules and restrictions applicable within the United States, while such restrictions may not be applicable in other regions, such as Mexico or Canada. Information related to the location-based restrictions may be provided within a memory of the communication device.

At block 406, a determination is made as to whether the power level of the RF signal source requires adjustment based on the detected location and the location-based restrictions. If no adjustment is required, the process ends. Otherwise, at block 408, the power level of the RF signal source is adjusted based on the detected geographic location and the location-based restrictions.

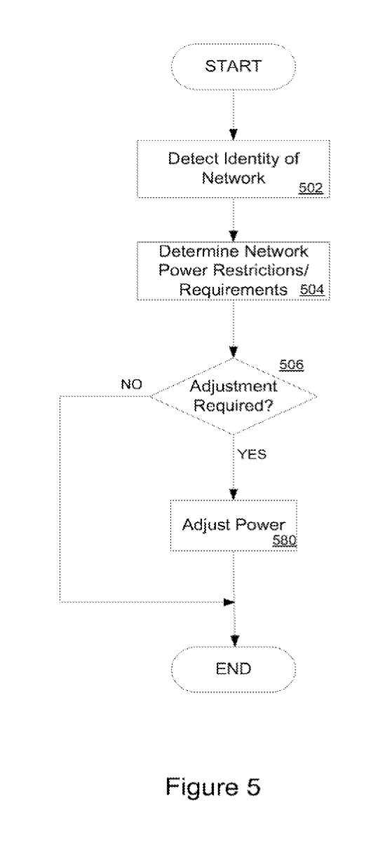

In another embodiment, the power level may be adjusted based on the network being used by the device, as illustrated in the example flow chart of FIG. 5. The method comprises determining the identity of the network (block 502) being interfaced by the device, or the RF signal source. At block 504, network restrictions or requirements applicable to the power level of the RF signal source are determined For example, if the device is being used with a primary service provider in the U.S., the power level of the RF signal source may be dropped to a predetermined reduced level. If, however, the device is being used in another country, such as Brazil, the network may be that of a roaming partner of the primary service provider which may require a different power level. Information related to the roaming partners and corresponding power requirements may be provided within a memory of the communication device.

At block 506, a determination is made as to whether the power level of the RF signal source requires adjustment based on the detected network. If no adjustment is required, the process ends. Otherwise, at block 508, the power level of the RF signal source is adjusted based on the detected network and the corresponding power requirements.

Various embodiments of the present invention may be implemented in a system having multiple communication devices that can communicate through one or more networks. The system may comprise any combination of wired or wireless networks such as a mobile telephone network, a wireless Local Area Network (LAN), a Bluetooth personal area network, an Ethernet LAN, a wide area network, the Internet, etc.

Communication devices may include a mobile telephone, a personal digital assistant (PDA), a notebook computer, etc. The communication devices may be located in a mode of transportation such as an automobile.

The communication devices may communicate using various transmission technologies such as Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc.

An electronic device in accordance with embodiments of the present invention may include a display, a keypad for input, a microphone, an ear-piece, a battery, and an antenna. The device may further include radio interface circuitry, codec circuitry, a controller and a memory.

Various embodiments described herein are described in the general context of method steps or processes, which may be implemented in one embodiment by a software program product or component, embodied in a machine-readable medium, including executable instructions, such as program code, executed by entities in networked environments. Generally, program modules may include routines, programs, objects, components, data structures, etc. that perform particular tasks or implement particular abstract data types. Executable instructions, associated data structures, and program modules represent examples of program code for executing steps of the methods disclosed herein. The particular sequence of such executable instructions or associated data structures represents examples of corresponding acts for implementing the functions described in such steps or processes.

Software implementations of various embodiments of the present invention can be accomplished with standard programming techniques with rule-based logic and other logic to accomplish various database searching steps or processes, correlation steps or processes, comparison steps or processes and decision steps or processes.

The foregoing description of various embodiments have been presented for purposes of illustration and description. The foregoing description is not intended to be exhaustive or to limit embodiments of the present invention to the precise form disclosed, and modifications and variations are possible in light of the above teachings or may be acquired from practice of various embodiments of the present invention. The embodiments discussed herein were chosen and described in order to explain the principles and the nature of various embodiments of the present invention and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. An apparatus, comprising:
a radio frequency (RF) signal source;
a proximity sensor configured to determine proximity of the RF signal source to live tissue; and
a controller configured to adjust power of the RF signal source based on the determined proximity of the RF signal source to the live tissue.

2. The apparatus of claim 1, wherein the RF signal source is an RF antenna.

3. The apparatus of claim 1, wherein the controller is configured to reduce the power of the RF signal source when the proximity is less than a predetermined threshold value.

4. The apparatus of claim 3, wherein the controller is configured to reduce the power to a predetermined reduced power level.

5. The apparatus of claim 3, wherein the controller is configured to reduce the power to a level corresponding to the proximity to the live tissue.

6. The apparatus of claim 3, wherein the predetermined threshold value is associated with a maximum distance required for an acceptable specific absorption rate (SAR) level.

7. The apparatus of claim 1, wherein the controller is configured to adjust the power to result in a SAR for the live tissue from the RF signal source to be no greater than a predetermined SAR.

8. The apparatus of claim 7, wherein to adjust the power to result in the SAR, the controller is further configured to calculate a maximum power value required for an acceptable SAR based on the determined proximity.

9. The apparatus of claim 1, wherein the proximity sensor is an optical proximity sensor.

10. The apparatus of claim 1, wherein the proximity sensor includes an accelerometer configured to determine an orientation of the RF signal source.

11. The apparatus of claim 1, wherein the controller is configured to adjust the power based on an inverse relationship between power level of the RF signal source and the proximity of the RF signal source to the live tissue.

12. A method, comprising:
detecting, via a proximity sensory, proximity of a radio frequency (RF) signal source to live tissue; and
adjusting power of the RF signal source based on the detected proximity.

13. The method of claim 12, wherein the RF signal source is an RF antenna.

14. The method of claim 12, wherein the adjusting of the power includes reducing the power of the RF signal source when the proximity is less than a predetermined threshold value.

15. The method of claim 14, wherein the power is reduced to a predetermined reduced power level.

16. The method of claim 14, wherein the power is reduced to a level corresponding to the proximity to live tissue.

17. The method of claim 16, wherein the predetermined threshold value is associated with a maximum distance required for an acceptable specific absorption rate (SAR) level.

18. The method of claim 12, wherein the power is adjusted to result in a SAR for the live tissue from the RF signal source to be no greater than a predetermined SAR.

19. The method of claim 18, further comprising calculating a maximum power value required for an acceptable SAR based on the determined proximity.

20. The method of claim 12, wherein the adjusting of the power is based on an inverse relationship between power level of the RF signal source and the proximity of the RF signal source to the live tissue.
